(19) United States
(12) Patent Application Publication
(10) Pub. No.: US 2026/0135594 A1
(43) Pub. Date: May 14, 2026

(54) BEAMSPACE COMPRESSION FOR SOUNDING REFERENCE SIGNALS

(71) Applicant: Intel Corporation, Santa Clara, CA (US)

(72) Inventors: Bishwarup Mondal, San Ramon, CA (US); Thushara Hewavithana, Tempe, AZ (US); Dae Won Lee, Portland, OR (US); Neelam Chandwani, Portland, OR (US); Ranjit Cavatur, Laguna Niguel, CA (US); Gang Xiong, Beaverton, OR (US); Debdeep Chatterjee, San Jose, CA (US)

(21) Appl. No.: 19/339,794

(22) Filed: Sep. 25, 2025

Related U.S. Application Data
(60) Provisional application No. 63/699,047, filed on Sep. 25, 2024.
(60) Provisional application No. 63/773,808, filed on Mar. 18, 2025.

(51) Int. Cl. H04B 7/06; H04L 5/00

(52) U.S. Cl. CPC H04B 7/0617; H04L 5/0051

(57) ABSTRACT

An apparatus and system for beamspace compression of Sounding Reference Signals (SRS) in wireless communication systems are described. High-dimensional SRS data exchanged between radio units (RUs) and distributed units (DUs) are compress using spatial correlation in antenna arrays and transform bases. Compressed coefficients are allocated and quantized, and pre- and post-channel estimation SRS data are supported. Active beamspace coefficients and associated basis information are transmitted from the RU to DU. Signaling mechanisms convey configuration and assistance data, including time-offset alignment, compression thresholds, and basis selection are transmitted from the DU to RU. Dynamic control of compression ratio, spatial resolution, and basis persistence are supported and used in advanced antenna configurations such as massive multiple-input-multiple-output (MIMO) and beamforming.

### PRIORITY

This application claims the benefit of priority to U.S. Provisional Patent Application Ser. No. 63/699,047, filed Sep. 25, 2024, and U.S. Provisional Patent Application Ser. No. 63/773,808, filed Mar. 18, 2025, each of which is incorporated herein by reference in its entirety.

### TECHNICAL FIELD

The present disclosure pertains to wireless communications. In particular, the disclosure is related to beamspace compression of Sounding Reference Signals (SRS) in radio units (RUs).

### BACKGROUND

Mobile communication has evolved significantly from early voice systems to highly sophisticated integrated communication platform. Next-generation (NG) wireless communication systems, including 5th generation (5G) and sixth generation (6G) or new radio (NR) systems, are to provide access to information and sharing of data by various user equipment (UEs) and applications. NR is to be a unified network/system that is to meet vastly different and sometimes conflicting performance dimensions and services driven by different services and applications. As such, the complexity of such communication systems, as well as interactions between elements within a communication system, has increased. In particular, wireless communication systems increasingly rely on advanced antenna configurations and reference signals to support high-speed data services and adaptive network management. As these systems evolve, efficiently handling the large volumes of reference signal data exchanged between radio units and distributed units presents ongoing challenges in maintaining throughput, flexibility, and overall network performance.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, according to some examples.

FIG. 1B illustrates a non-roaming 5G system architecture, according to some examples.

FIG. 1C illustrates a non-roaming 5G system architecture, according to some examples.

FIG. 2 illustrates a block diagram of a communication device, according to some examples.

FIG. 3 illustrates a configuration in which multiplexed ports are separated into per-port channel estimate, according to some examples.

FIG. 4 illustrates SRS beamspace compression after channel estimation, according to some examples.

FIG. 5 illustrates SRS beamspace compression without channel estimation, according to some examples.

FIG. 6 illustrates interlaces defined as partitions within an SRS comb, according to some examples.

FIG. 7 illustrates a method of compression at a radio unit (RU), according to some examples.

FIG. 8 illustrates a method of decompression at a distributed unit (DU), according to some examples.

FIG. 9 illustrates interlace beamspace compression of SRS channel estimates, according to some examples.

FIG. 10 illustrates a method of compressed SRS transmission, according to some examples.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

The following detailed description provides illustrative examples of the disclosed subject matter and is intended to enable those skilled in the art to make and use the described technology. The disclosed subject matter pertains to the field of wireless communications, with a particular focus on techniques for beamspace compression of SRS in RUs to optimize uplink fronthaul throughput in next-generation networks, such as 5G and 6G systems. The described methods and systems address challenges associated with managing high-dimensional SRS data while maintaining efficient and flexible communication between distributed units (DUs) and RUs.

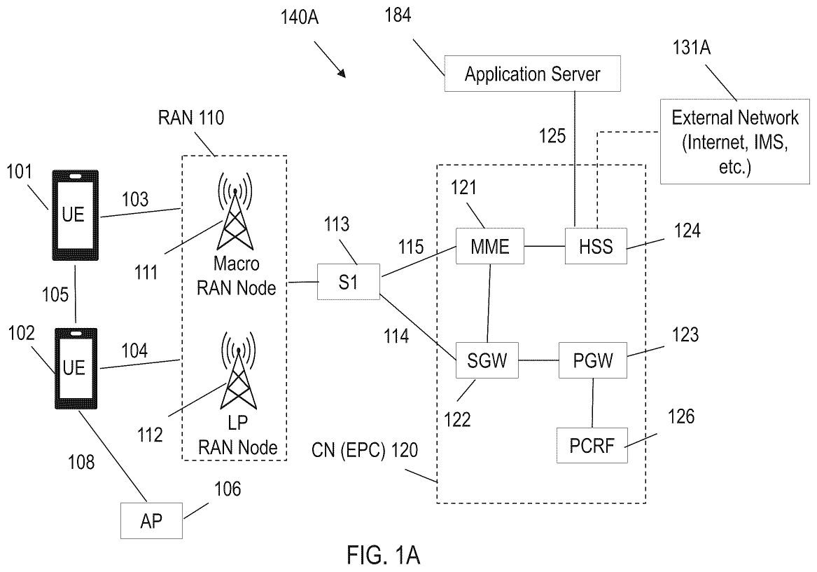

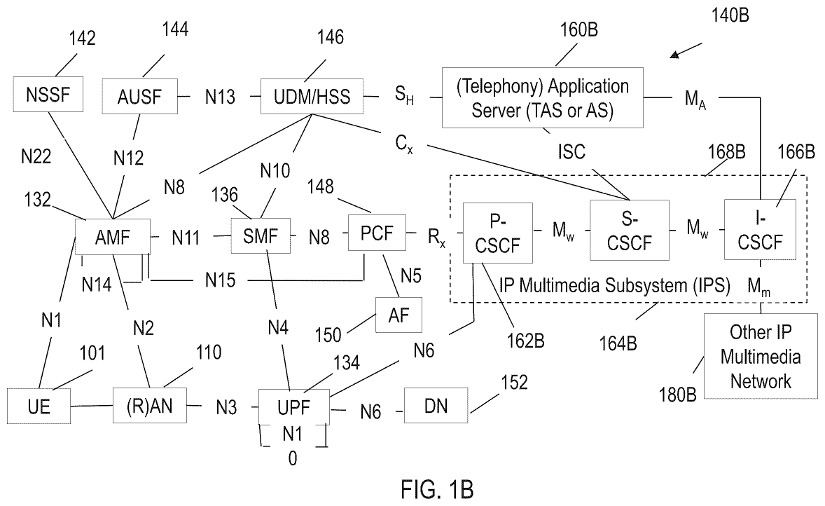

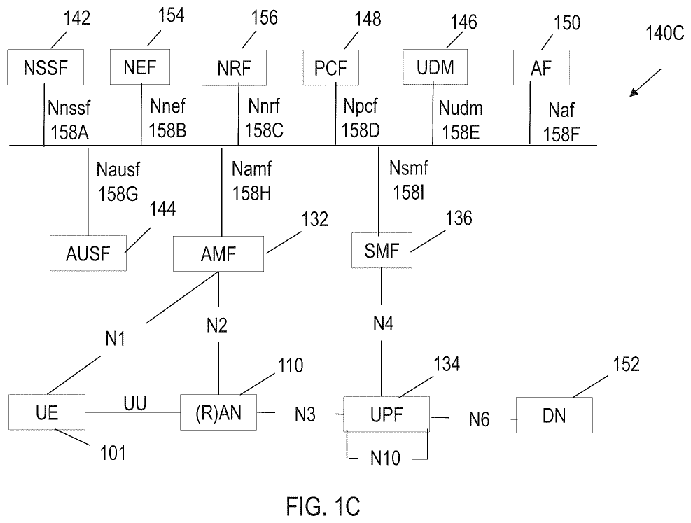

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHZ, 3.4-3.6 GHz, 3.6-3.8 GHz, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

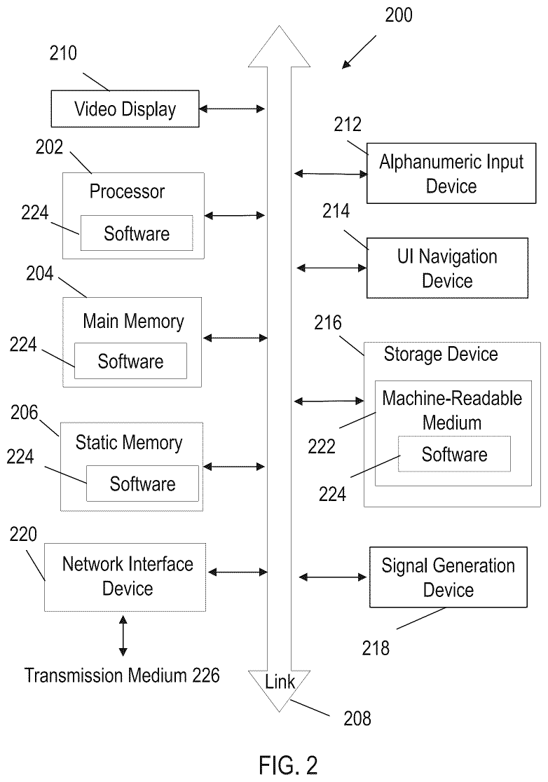

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHZ (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHZ bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHZ, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHZ (typically 5.85-5.925 GHz) and 63-64 GHz, bands currently allocated to WiGig such as WiGig Band 1 (57.24-59.40 GHz), WiGig Band 2 (59.40-61.56 GHZ) and WiGig Band 3 (61.56-63.72 GHZ) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHZ, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, in wireless communication systems, base stations and distributed units work together to provide high-speed data services to a diverse range of user devices. These systems are progressively incorporating advanced antenna configurations such as massive multiple-input-multiple-output (MIMO) and beamforming to address demanding requirements for throughput, coverage, and reliability.

Sounding Reference Signals (SRS) are instrumental in facilitating accurate channel estimation and adaptive beam management. SRS traverse the fronthaul interface between radio units and distributed units. As next-generation networks progress toward open architectures and standardized interfaces, managing SRS data efficiently maintains end-to-end performance.

To realize scalable and interoperable deployments, operators seek fronthaul solutions that balance throughput efficiency with configuration flexibility. Support for multi-user multiplexing and dynamic beam adaptation involves precise and timely channel information without overburdening the transport link. Industry efforts have converged on open interfaces that permit centralized coordination of antenna resources while accommodating diverse radio-unit implementations. Within this context, there is a growing demand for mechanisms that can control compression levels and spatial granularity of channel measurements, as well as signaling methods for conveying configuration and assistance data.

Despite advances in compression techniques and fronthaul protocols, existing approaches may struggle to manage the high dimensionality of SRS data when multiple antenna ports are multiplexed via cyclic shifts or resource combs. In many scenarios, channel estimation at the radio unit expands the data volume by separating multiplexed ports, resulting in a substantial increase in fronthaul throughput requirements. Conventional compression schemes often overlook the spatial correlation characteristic of antenna arrays or necessitate significant computational complexity, limiting their practicality for real-time operation.

A more targeted challenge arises when attempting to reduce the transport of SRS port estimates or raw SRS waveforms while preserving sufficient spatial resolution for beamforming at the distributed unit. Constraints on the number of compressed coefficients, the design of transform bases, and the allocation of control parameters for comb-based configurations all contribute to a complex trade-off space. Moreover, signaling assistance information such as time-offset alignment or compression thresholds may involve careful coordination to ensure accurate reconstruction without imposing excessive overhead.

In more detail, definitions of input output blocks for SRS beamspace compression blocks in a RU are provided, as is signalling from the DU to the RU for assistance and control of spatial resolution and compression ratio of beamspace compression, and compressed SRS coefficients and side information used for decompression that is sent from the RU to the DU. Various embodiments may allow for or facilitate a standardized interface between the DU and the RU while allowing for beamspace compression of SRS at the RU. This interface and/or beam compression may be possible without SRS channel estimation at the RU or with channel estimation of SRS at the RU.

### SRS Comb Structure and UE Port Assignments:

Note that SRS from multiple transmit (Tx) ports of the same UE may be multiplexed on the same resource element (RE) using cyclic shift (CS). SRS transmission from different UEs may also be multiplexed using CS (on the same RE). Some example max CS dimensions (based on frequency dimension sampling or comb factor K_{TC}) are shown below:

| K_{TC} | ${n}_{S R S}^{cs , max}$ |
|---|---|
| 2 | 8 |
| 4 | 14 |
| 8 | 6 |

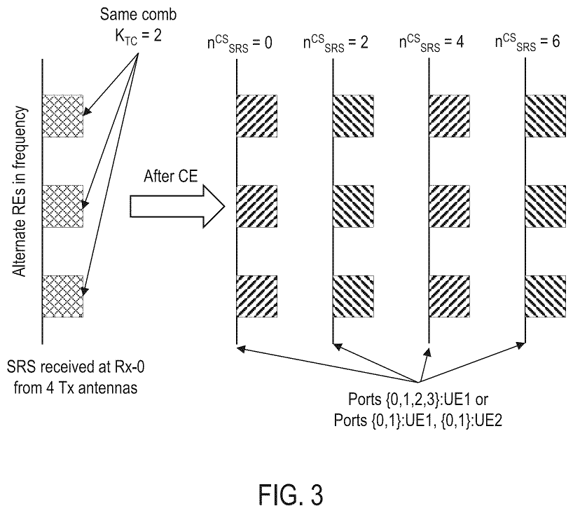

After channel estimation of SRS, the dimension of SRS data “expands” by the used CS dimensions. This is shown in FIG. 3, which illustrates a configuration in which multiplexed ports are separated into per-port channel estimate, according to some examples. The configuration is shown in FIG. 3 after channel estimation, where all the 4 SRS ports that are multiplexed via CS on the same RE are separated into per-port channel estimate. This separation may increase the dimension of the SRS data after channel estimation that is transmitted over the fronthaul (as opposed to transmitting SRS data before channel estimation).

SRS Beamspace Compression after Channel Estimation:

After channel estimation is performed at the RU, the SRS data expands in dimensionality as multiplexed ports are separated into individual channel estimates. The RU then applies a transform, such as SVD, DFT, or QR decomposition, to convert the SRS data from the antenna domain to the beam domain. Only the high-energy coefficients in the beam domain are retained, while low-energy coefficients are dropped, thereby reducing the data volume for fronthaul transmission. The RU quantizes the retained coefficients and transmits them, along with the basis information, to the DU. The DU uses this information to reconstruct the original SRS data for further processing, such as beamforming and resource management. The RU may thus select, based on a threshold received from configuration information, a subset of beamspace coefficients corresponding to high-energy coefficients of the SRS signals in the beam domain.

The RU thus uses various information related to the SRS data, including compression threshold, basis selection, coefficient selection, or synchronization parameters.

A compression threshold is used to determine which coefficients are retained during the compression process. In the context of beamspace compression for SRS, the threshold is typically set so that only coefficients with energy or magnitude above a certain level are retained, while those below the threshold are discarded or set to zero. This reduces the amount of data that needs to be transmitted, saving fronthaul bandwidth while preserving the most significant information.

Basis selection refers to the process of choosing the mathematical basis or set of vectors used to transform the SRS data from the antenna domain to the beam domain. The bases include DFT, oversampled DFT, SVD, and QR decomposition. The selected basis determines how the data is represented, as well as which components are most suitable for compression and reconstruction.

Coefficient selection is the process of choosing which transformed coefficients (resulting from the basis transformation) are transmitted to the DU. After the SRS data is projected onto the selected basis, only a subset of coefficients is selected for quantization and transmission. This further reduces the data volume and focuses on the most relevant information for channel estimation and beamforming.

Synchronization parameters are settings or information used to ensure that the RU and DU are aligned in time and configuration during the compression, transmission, and reconstruction processes. These may include timing offsets (such as FFT window placement), symbol timing, or other parameters that ensure the DU can accurately reconstruct the SRS data using the same reference points and configurations as the RU. Proper synchronization is used for maintaining data integrity and system performance.

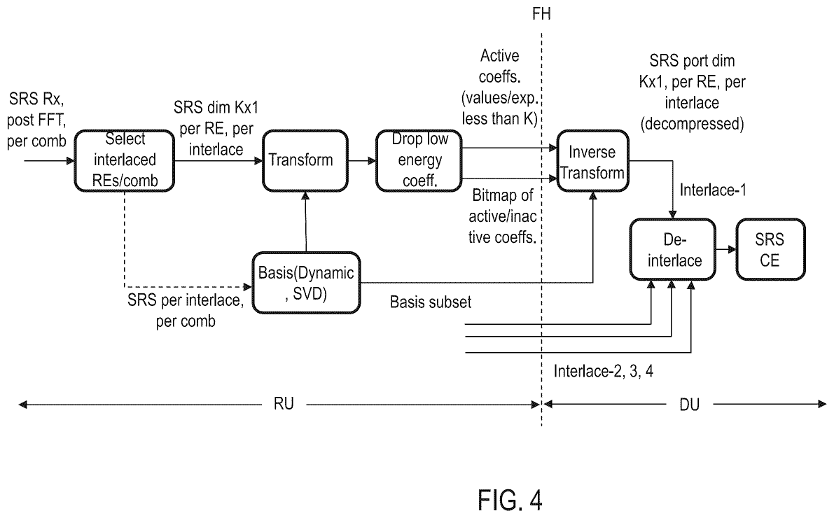

FIG. 4 illustrates SRS beamspace compression after channel estimation, according to some examples. SRS beamspace compression is shown at the RU.

The input to SRS channel estimation (CE) may include (post Fourier frequency transform (FFT)) SRS REs per comb. The input RE dimension is K×1, where K=P×M×N, P is the number of polarizations, M is the number of rows and N is the number of columns of the Rx antenna array. The SRS CE may perform separate CE per Rx antenna. The input to the transform block is an SRS K×1 vector corresponding to an SRS RE, port, comb along with a transform basis. The input to the basis selection/construction block is a set of SRS K×1 vectors corresponding to T ports in the comb.

The compressed SRS coefficient values (I and Q) and exponent may be quantized at the RU and de-quantized at the DU using methods such as block floating point (FP) compression, block scaling compression or u-law compression (quantization not shown in FIG. 4).

Block floating point compression is a quantization technique in which a block of values is represented using a shared exponent and individual mantissas. Instead of representing each value with its own floating point format, the block shares a common exponent, which reduces the number of bits used for storage and transmission. This method is efficient for compressing data with similar magnitude, such as beamspace coefficients, and helps save bandwidth while maintaining reasonable precision.

Block scaling compression is a quantization method in which a block of values is scaled by a common scaling factor before quantization. The scaling factor is chosen so that the values in the block fit within a desired numeric range (such as the range of an integer type). After scaling, the values are quantized and transmitted along with the scaling factor. At the receiver, the values are de-quantized by applying the inverse scaling. This approach is useful for compressing data with varying dynamic range, such as SRS coefficients, and helps optimize the use of available bits.

u-law compression is a nonlinear quantization technique that compresses the dynamic range of a signal by applying a logarithmic transformation, which allocates more quantization levels to smaller values and fewer levels to larger values. This is effective for signals in which small values are more frequent, such as certain communication signals. In the context of beamspace coefficients, u-law compression helps preserve detail in low-amplitude coefficients while reducing the overall data size.

Synchronization between the RU and DU is maintained through detailed control signaling. The DU communicates not only the compression threshold and basis selection, but also explicit identification of which coefficients are to be retained and which are to be zeroed out during compression. This ensures that the DU can accurately reconstruct the compressed SRS data, minimizing information loss and maintaining the integrity of channel estimates. The signaling protocol may also include instructions for the frequency and granularity of basis updates, as well as the association of coefficients to specific basis vectors.

The active beamspace coefficients may be sent from the RU to the DU. The association of the active coefficients to the basis vector may be sent from the RU to the DU. The basis vectors that have at least one active coefficient may also be sent from the RU to the DU. For an oversampled discrete Fourier transform (DFT), an oversampling index may be sent that is sufficient to identify the basis. The active beamspace coefficients and the association of the coefficients to the basis vector is sent at the same time. The basis vectors can be sent to the DU at a lower frequency.

Assistance information and control information for SRS beam-space compression may be sent from DU to RU as indicated below.

Assistance Information Sent from the DU to the RU

Time offset information may be applied (e.g., for FFT window placement) at the RU for an SRS comb. This information may be sent on a per symbol basis or per UE-id basis (along with association of UE-id to SRS symbol)

Control Information for Compressed SRS Coefficients Sent from the DU to the RU

A threshold may be used by the RU for selection of active coefficients from a set of K transform domain coefficients.

Embodiments may further relate to restrictions on the number of compressed SRS coefficients that controls the compression ratio and the fronthaul (FH) bandwidth. The restriction may be indicated in different ways, e.g., a number (or maximum number) of active compressed coefficients per comb, per UE-Id, per K×1 SRS vector, per K×T SRS matrix, per section-id, or per PRB set of SRS sounding bandwidth, or per symbol or a combination of the above options.

Embodiments may further relate to an indication to switch off SRS beamspace compression (quantization still applied) at the RU. This ability may be defined in different granularities, e.g., per comb, per UE-id, per K×1 SRS vector, per K×T SRS matrix, per section-id, per PRB set of SRS sounding bandwidth, or per symbol or a combination of the above options.

Word length of each I and Q value after quantization. The word length refers to the number of bits used to represent each quantized value in digital form. The word length determines the precision and range of the stored or transmitted data. For example, a word length of 8 bits allows for 256 distinct values, while a word length of 16 bits allows for 65,536 distinct values.

Control Information for Basis Construction Sent from DU to RU

Some embodiments may relate to an indication of a type of basis to be used for the SRS. This indication may include setting one of many declared options that is supported by a RU. The options supported by a RU may include, for example, 1 dimensional (1D or 1-D) DFT, two dimensional (2D or 2-D)-DFT, oversampled 1-D DFT, oversampled 2-D DFT, singular value decomposition (SVD), or simplified implementation of SVD including QR.

Embodiments may relate to restriction on the application of the same basis to SRS K×1 vectors. The same basis may be applied to SRS K×1 vectors from the same comb, to SRS K×1 vectors from the same SRS symbol, to SRS K×1 vectors from the same transmit (Tx) port (UE-ID), to SRS K×1 vectors within the same section-id, to SRS K×1 vectors within the same physical resource block (PRB) set of SRS sounding bandwidth, or a combination of the above options.

A comb refers to a specific pattern of REs in the frequency domain used for transmitting SRS signals. Applying an identical basis to SRS signals from the same comb means that all SRS data associated with that particular comb are transformed using the same mathematical basis (such as DFT, SVD, or QR). This ensures consistency in how the data is compressed and later reconstructed for all signals within that comb. Similarly, applying an identical basis to SRS signals from the same SRS symbol means that all SRS data received during that symbol are processed using the same basis. This is useful for maintaining uniformity in compression across all SRS signals within a given time slot. Applying an identical basis to SRS signals from the same transmit port means that all SRS data originating from that port are transformed using the same basis. This can simplify processing and ensure that the characteristics of that port are consistently represented in the compressed data. A section-id is an identifier for a specific section or segment of the SRS transmission, which may correspond to a particular frequency or time allocation. Applying an identical basis to SRS signals from the same section-id means that all SRS data within that section are processed using the same basis, ensuring consistent compression and reconstruction for that segment. Applying an identical basis to SRS signals from the same PRB set means that all SRS data within that frequency allocation are transformed using the same basis.

The interlace introduced herein is highly flexible, allowing the partitioning of the SRS comb into any number of interlaces, independent of the number of multiplexed SRS ports. For example, even if only two ports are multiplexed, four or more interlaces may be defined for compression purposes. This flexibility enables the system to optimize compression efficiency and adapt to various SRS configurations, providing a robust solution for different deployment scenarios. The number and periodicity of interlaces can be dynamically configured based on system requirements and control signaling from the DU.

In certain embodiments, after channel estimation is performed at the RU, the estimated SRS ports are recombined into a composite waveform using specific sequences before being partitioned into interlaces for compression. This process ensures that the compressed data benefits from noise reduction and improved signal quality. The protects both direct interlace compression of received SRS and compression of recombined, post-channel-estimation SRS data. The composite waveform generation step involves multiplying each channel estimate by a defined sequence and summing the results, as described in the mathematical formulation provided herein.

Some embodiments may relate to restriction on the input SRS K×1 vector outer products used for a single basis construction. The options for this indication may include, for example, SRS K×1 vectors from the same comb, SRS K×1 vectors from the same SRS symbol, SRS K×1 vectors from the same Tx port (UE-ID), SRS K×1 vectors within the same section-id, SRS K×1 vectors within the same PRB set of SRS sounding bandwidth, or a combination of the above options.

Some embodiments may relate to persistence and the window of validity of such persistence of variables to allow filtering of SRS K×1 vectors across time/frequency for basis construction or SRS CE. The variables may include, for example, UE-ID association with one or more of the following-SRS comb, cyclic shift, SRS symbol, SRS PRB sets, section-id.

SRS Beamspace Compression without Channel Estimation:

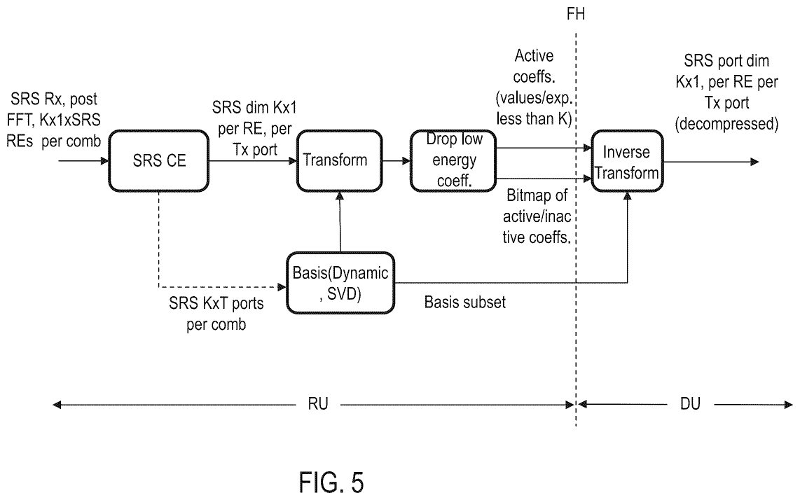

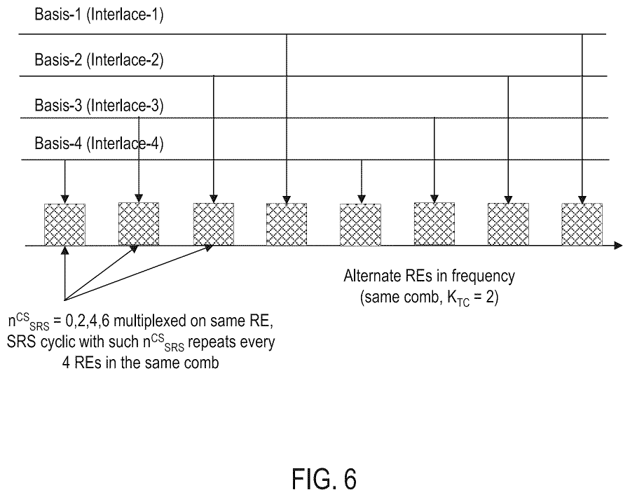

FIG. 5 illustrates SRS beamspace compression without channel estimation, according to some examples. FIG. 6 illustrates interlaces defined as partitions within an SRS comb, according to some examples.

The input to the block that selects an SRS interlace may be the set of SRS K×1 vectors per comb. Note that this SRS may be the received signal after FFT and before CE, therefore all SRS Tx ports in the cyclic shift domain may be aggregated along with the presence of interference and receiver noise. The input to the transform block is an SRS K×1 vector corresponding to an SRS RE, port, comb along with a transform basis. The input to the basis selection/construction block may be a set of SRS K×1 vectors corresponding an interlace within a comb. An interlace may be defined as a partition of REs within a comb that are selected with a certain periodicity. If a periodicity of L REs is selected for an interlace, then a comb is partitioned into L interlaces where each interlace may include one or more REs with a periodicity of L.

The compressed SRS coefficient values (I and Q) and exponent are quantized at the RU and de-quantized at the DU using methods such as block FP compression, block scaling compression, or u-law compression (quantization not shown).

The active beamspace coefficients are sent from the RU to the DU. The association of the active coefficients to the basis vector is sent from the RU to the DU. The basis vectors that have at least one active coefficient is also sent from the RU to the DU. In the case of oversampled DFT, an oversampling index is sent that is sufficient to identify the basis. The active beamspace coefficients and the association of the coefficients to the basis vector is sent at the same time. The basis vectors can be sent to the DU at a lower frequency.

Assistance information and control information for SRS beam-space compression is sent from the DU to the RU.

Assistance Information Sent from DU to RU

Some embodiments may relate to time offset information that can be applied (e.g. for FFT window placement) at the RU for a SRS symbol. This can be sent on a per symbol basis or per UE-id basis (along with association of UE-id to SRS symbol).

Control Information for Compressed SRS Coefficients Sent from DU to RU

Some embodiments may relate to a threshold to be used by RU for selection of active coefficients from a set of K transform domain coefficients.

Some embodiments may relate to restrictions on the number of compressed SRS coefficients that controls the compression ratio and the FH bandwidth. The restriction may be indicated in different ways, e.g., a number (or maximum number) of active compressed coefficients per interlace, per comb, per K×1 SRS vector, per section-id, per PRB set of SRS sounding bandwidth, per symbol, or a combination of the above options.

Some embodiments may relate to an indication to switch off SRS beamspace compression (quantization still applied) at the RU. This ability may be defined in different granularities, e.g., per interlace, per comb, per K×1 SRS vector, or per section-id, per PRB set of SRS sounding bandwidth, per symbol, or a combination of the above options.

Word length of each I and Q value after quantization.

Control Information for Basis Construction Sent from DU to RU

Some embodiments may relate to an indication of a type of basis to be used for SRS. This indication may include setting one of many declared options that is supported by a RU. The options supported by a RU may include one or more of 1-D DFT, 2D-DFT, oversampled 1-D DFT, oversampled 2-D DFT, SVD, or simplified implementation of SVD including QR.

Some embodiments may relate to an indication of restriction on the application of the same basis to SRS K×1 vectors. The same basis may be applied to SRS K×1 vectors from the same interlace, to SRS K×1 vectors within the same section-id, to SRS K×1 vectors within the same PRB set of SRS sounding bandwidth, or a combination of the above options.

Some embodiments may relate to an indication of restriction on the input SRS K×1 vector outer products used for a single basis construction. The options for this indication may include one or more SRS K×1 vectors from the same interlace, SRS K×1 vectors within the same section-id, SRS K×1 vectors within the same PRB set of SRS sounding bandwidth, or a combination of the above options.

Some embodiments may relate to an indication of persistence and the window of validity of such persistence of variables to allow filtering of SRS K×1 vectors across time/frequency for basis construction or SRS CE. The variables may include UE-ID association with one or more of the following-SRS interlace, comb, cyclic shift, SRS symbol, SRS PRB sets, section-id.

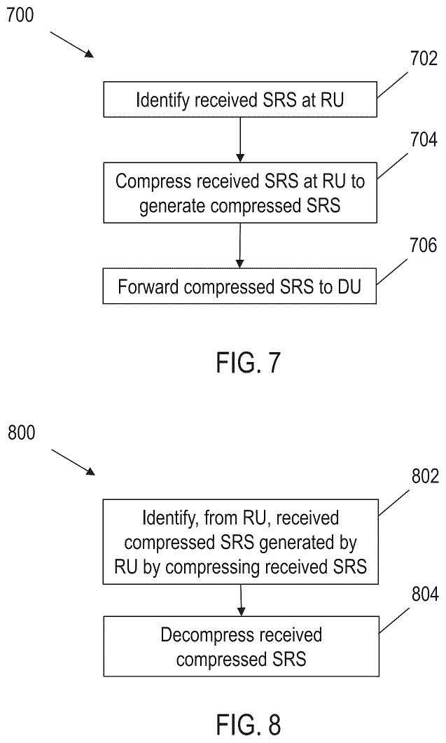

FIG. 7 illustrates a method of compression at a RU, according to some examples. In some embodiments, the electronic device(s), network(s), system(s), chip(s) or component(s), or portions or implementations thereof, of the above figures, or some other figure herein, may be configured to perform one or more processes, techniques, or methods as described herein, or portions thereof. The method 700 of FIG. 7 may include or relate to a method to be performed by a RU of a base station of a cellular network. The method 700 may include identifying, at step 702, a received SRS at the RU; compressing, at step 704, the received SRS at the RU to generate a compressed SRS; and forwarding, at step 706, the compressed SRS to a DU of the base station.

FIG. 8 illustrates a method of decompression at a distributed unit (DU), according to some examples. The method 800 of FIG. 8 may include or relate to a method to be performed by a DU of a base station of a cellular network. The method 800 may include or relate to identifying, at step 802 from a RU of the base station, a received compressed SRS, wherein the compressed SRS is generated by the RU by compressing a received SRS received by the RU; and decompressing, at step 804, the received compressed SRS.

Methods to achieve beamspace compression of SRS channel estimates determined at the RU are also described. Such methods may save uplink fronthaul throughput from a RU that is capable of SRS channel estimation and a DU. The methods involve compression of SRS channel estimates at the RU, transmission of compressed channel estimates to the DU, and reconstruction of the SRS channel estimates at the DU.

In the following, Nes is used to denote the number of SRS Tx ports compressed using a single beam compression basis.

### SRS Tx Port:

An SRS Tx port (m-th port) can be represented by a N_{Rx}×1 column vector h_{k,m} on the k-th subcarrier where k takes N_{BW} different values. The subcarriers are uniformly spaced in frequency domain (as in a comb) within a part-bandwidth BW. N_{Rx} is the number of BS Rx antenna ports.

### Pool of SRS Tx Ports:

A pool of estimated SRS Tx ports refers to a set of SRS Tx ports estimated from the received SRS waveforms at the RU (from the air-interface) over one or more OFDM symbols. Consequently, this set includes SRS transmitted from the same Tx port of an UE (repetition), different Tx ports of an UE (antenna selection) or different UEs over multiple symbols.

### N_{cs} SRS Tx Port Selection:

N_{cs} SRS Tx ports are selected from a pool of estimated SRS Tx ports such that the time-domain impulse response of each Tx port occupies less than

$$\frac{1}{{N}_{c s}}$$

part of an OFDM symbol time and the frequency-domain representation of each Tx port consists of the same number of samples N_{BW}.

Note that each SRS Tx port within the set of N_{cs} SRS Tx ports may represent a different part-bandwidth, both in terms of the location of the part-bandwidth and the size of the part-bandwidth. Also, each SRS Tx port within the set of N_{cs} SRS Tx ports may represent a different set of sub-carriers even if they belong to the same part-bandwidth.

Processing may be used after SRS channel estimation in some cases to align number of samples within the part-bandwidth and contain the length of time-domain impulse response within this set of N_{cs} SRS Tx ports.

### SRS Composite Waveform Generation:

The selected N_{cs} SRS Tx ports can be used to generate a composite waveform h_{k,cs} from h_{k,m}, m=1, . . . , N_{cs} that can be represented by

$${h}_{k , cs} = {\sum }_{m = 1}^{{N}_{c s}} {h}_{k , m} {s}_{k , m} where k = 1 , 2 , … , {N}_{B W} \cdot {s}_{k , m} = {α}_{m} {e}^{j 2 π \frac{{n}_{m}}{{M}_{cs}} k} r ( k ) , where {M}_{c s} \geq {N}_{c s} and 0 \leq {n}_{m} \leq {M}_{c s}$$

is a cyclic shift corresponding to the m-th port, am is a scaler for power adjustment, r(k) is a common sequence across all the SRS Tx ports.

### SRS Interlace Waveform Generation:

The composite waveform h_{k,cs}, k=1, 2, . . . , N_{BW} is split into P_{cs} mutually exclusive subsets denoted by hₖ_{ᵢ}_{,cs}, i=1, 2, . . . , P_{cs} where P_{cs}≥N_{cs}. Each subset is called an interlace. One example of defining an interlace is given by defining the index kᵢ corresponding to the i-th interlace by kᵢ=i, i+P_{cs}, i+2P_{cs}, . . . , N_{BW}/P_{cs}

### SRS Interlace Basis Generation:

A compression basis Sᵢ of size N_{Rx}×Nₛ is determined for the i-th interlace, where Nₛ is the number of streams (in the transform domain). The compression ratio is given by N_{Rx}/Nₛ.

In one example

$${Q}_{i} = svd ( {\sum }_{{k}_{i}} {h}_{{k}_{i} , c s} {h}_{{k}_{i} , cs}^{H} )$$

where Qᵢ are the normalized singular vectors of

$${\sum }_{{k}_{i}} {h}_{{k}_{i} , c s} {h}_{{k}_{i} , cs}^{H} .$$

Then Sᵢ consists of Nₛ singular vectors chosen from Qᵢ corresponding to the largest Nₛ singular values.

In one example a fixed N_{Rx}×Nₛ matrix X is used and Nₛ rows of X are chosen to form Sᵢ corresponding to the highest values of the diagonal elements according to

$$X ( {\sum }_{{k}_{i}} {h}_{{k}_{i} , cs} {h}_{{k}_{i} , cs}^{H} ) {X}^{H}$$

### SRS Interlace Coefficient Generation:

Corresponding to each i-th interlace, and a corresponding basis Sᵢ, a set of compression coefficients are determined given by

$${N}_{s} \times 1 vector {c}_{{k}_{i , cs}} = {S}_{i}^{H} {h}_{{k}_{i} , cs} ∀ {k}_{i}$$

### Reconstruction of SRS Waveform:

The SRS interlace waveform is reconstructed (i-th interlace) from cₖ_{ᵢ}_{,cs} and Sᵢ. One example is [symbol] =Sᵢcₖ_{ᵢ}_{,cs}. The composite SRS waveform [symbol] is reconstructed from each of the reconstructed interlace waveforms. One example is to combine all the P_{cs} interlaces to form [symbol] , k=1, 2, . . . , N_{BW} according to kᵢ=i, i+P_{cs}, i+2P_{cs}, . . . , N_{BW}/P_{cs}

### Reconstruction of N_{cs} SRS Tx Ports:

The reconstructed composite SRS waveform [symbol] together with the information on S_{k,m} can be used to reconstruct each of the SRS Tx ports

[symbol]

### Transmission of Beam Compression Information:

For each interlace, the compression coefficients cₖ_{ᵢ}_{,cs} and the basis information for Sᵢ are transmitted from the RU to the DU. The basis information could comprise of the basis coefficients (in the case of SVD for example) or an indication sufficient for reconstruction of the basis (e.g., indices of the selected basis vectors for a fixed basis already known between the RU/DU). In addition, Skim information is considered to be transmitted from the RU to the DU or known between the RU and the DU.

### Interlace Beamspace Compression of SRS Channel Estimates:

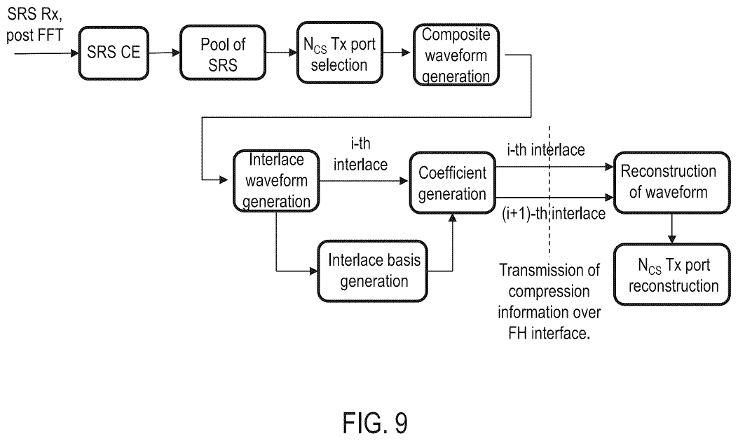

FIG. 9 illustrates interlace beamspace compression of SRS channel estimates, according to some examples.

Control Information for SRS Transport Sent from DU to RU:

An indication of a combination of SRS compression scheme and SRS channel estimation may be sent from the DU to the RU. In different aspects, beam compression with channel estimation or without channel estimation may be indicated from the DU to the RU.

An indication of a combination of multiple SRS compression schemes may be sent from the DU to the RU. In one aspect, beam compression with frequency domain decimation is indicated from the DU to the RU.

Control Information for Compressed SRS Coefficients Sent from DU to RU:

An indication of the frequency resolution of compressed SRS coefficients is sent from the DU to the RU. In one aspect, the frequency resolution of the compressed SRS coefficients is the same as the frequency resolution of the SRS comb configuration (once every 2 REs for K_{TC}=2, once every 4 REs for K_{TC}=4 or once every 8 REs for K_{TC}=8). In one aspect, the frequency resolution of the compressed SRS coefficients is indicated as K times per PRB or as once per K PRBs or as K times per M PRBs. In one aspect, the information that no compression coefficients should be sent from the RU to the DU is indicated from the DU to the RU.

Control Information for Compression Basis Sent from DU to RU:

An indication of the compression basis information is sent from the DU to the RU. In one aspect, whether one or two bases should be applied for a set of two Tx ports at the RU is indicated. In one aspect, whether basis information without compression coefficients should be transmitted from the RU to the DU tis indicated. In one aspect, the number of interlaces and/or the number of streams for compression basis information is sent from the DU to the RU.

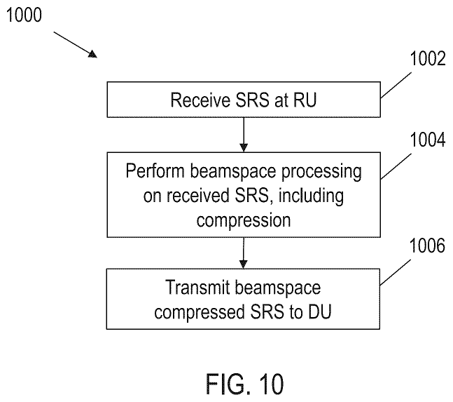

FIG. 10 illustrates a method of compressed SRS transmission, according to some examples. In some embodiments, the electronic device(s), network(s), system(s), chip(s) or component(s), or portions or implementations thereof, of the figures herein may be configured to perform one or more processes, techniques, or methods as described herein, or portions thereof. For example, the method 1000 may include, at step 1002, receive SRS signals at a RU. At step 1004, beamspace processing is performed on the received SRS signals, including compression. At step 1006, the beamspace compressed SRS signals are transmitted to a DU.

Thus, SRS data is compressed at the RU. SRS signals, which are used for channel estimation and beam management, are transmitted from multiple UE ports and multiplexed using CS techniques, resulting in complex, high-dimensional data. After channel estimation at the RU, the data expands as the multiplexed ports are separated into individual channel estimates, increasing the fronthaul bandwidth to transmit this information to the DU. Beamspace compression is introduced at the RU. The beamspace compression transforms the SRS data from the antenna domain to the beam domain using a selected basis (such as SVD, DFT, or QR), and then compresses the data by retaining only the high-energy coefficients and discarding the low-energy ones. The RU quantizes the coefficients and transmits the coefficients, along with the basis information, to the DU. The DU uses the coefficients and basis information to reconstruct the original SRS data for further processing. The system supports dynamic control and assistance signaling from the DU to the RU, including configuration of the compression threshold, selection of the basis type, and synchronization of parameters such as FFT window placement and coefficient selection. The process is designed to maximize efficiency by reducing the amount of data sent over expensive fronthaul links, such as Ethernet or optical cables, without significantly impacting the accuracy of channel estimates. The approach is flexible, supporting both pre- and post-channel estimation compression, and is intended to be interoperable with standardized interfaces, making it suitable for scalable deployment in next-generation wireless networks.

A technique for compressing SRS channel estimates at the RU is also described to optimize uplink fronthaul efficiency in wireless communication systems. This is useful when the RU is capable of performing SRS channel estimation, resulting in high-dimensional channel estimate data that is transmitted to the DU for further processing. The method involves selecting SRS transmit ports, generating composite waveforms, and partitioning the waveforms into interlaces, i.e., mutually exclusive subsets defined by periodicity in the frequency domain. For each interlace, a compression basis is constructed (using methods such as SVD), and corresponding compression coefficients are generated and transmitted to the DU along with basis information. The DU reconstructs the original SRS channel estimates using the received data. The system includes comprehensive control signaling from the DU to the RU, specifying compression schemes, frequency resolution, and basis application details. This interlace-based beamspace compression approach enables substantial reduction in fronthaul bandwidth requirements while preserving the accuracy and spatial resolution for advanced beamforming and resource management at the DU.

### EXAMPLES

Example 1 is an apparatus for a radio unit (RU), the apparatus comprising: a memory configured to store Sounding Reference Signal (SRS) signals received from one or more user equipment (UE) ports; and a processor that configures the RU to: receive SRS signals from a plurality of antenna elements; perform a transform operation on the SRS signals to convert the SRS signals from an antenna domain to a beam domain using a selected basis; select, based on a threshold received from configuration information, a subset of beamspace coefficients corresponding to high-energy coefficients of the SRS signals in the beam domain; quantize the subset of beamspace coefficients to form quantized beamspace coefficients; associate the quantized beamspace coefficients with basis information; and transmit the quantized beamspace coefficients and associated basis information for reconstruction of SRS data.

In Example 2, the subject matter of Example 1 includes, wherein the selected basis comprises at least one selected from a discrete Fourier transform (DFT), an oversampled DFT, a singular value decomposition (SVD), and a QR decomposition.

In Example 3, the subject matter of Examples 1-2 includes, wherein: the threshold is received from a distributed unit (DU), the processor configures the RU to receive control information from the DU, the control information comprises at least one selected from a compression threshold used to determine which coefficients of the SRS signals are retained during compression of the SRS signals, basis selection to indicate a mathematical basis used to transform the SRS data from the antenna domain to the beam domain, coefficient selection to select the subset of beamspace coefficients from among the coefficients of the SRS signals retained during the compression of the SRS signals, and synchronization parameters that align the RU and DU in time and configuration during compression, transmission, and reconstruction of the SRS data.

In Example 4, the subject matter of Examples 1-3 includes, wherein quantization of the subset of beamspace coefficients comprises application of at least one selected from block floating point compression, block scaling compression, and u-law compression to the subset of beamspace coefficients.

In Example 5, the subject matter of Examples 1-4 includes, wherein the processor configures the RU to transmit, along with the quantized beamspace coefficients, an indication of a word length of each quantized value.

In Example 6, the subject matter of Examples 1-5 includes, wherein the basis information comprises at least one selected from: actual basis vectors, indices identifying selected basis vectors, and oversampling factors.

In Example 7, the subject matter of Examples 1-6 includes, wherein: the threshold is received from a distributed unit (DU), and the processor configures the RU to receive time offset information from the DU for fast Fourier transform (FFT) window placement.

In Example 8, the subject matter of Examples 1-7 includes, wherein the processor configures the RU to apply an identical basis to SRS signals received from an identical comb, SRS symbol, transmit port, section-id, or physical resource block (PRB) set of SRS sounding bandwidth.

In Example 9, the subject matter of Examples 1-8 includes, wherein: the threshold is received from a distributed unit (DU), and the processor configures the RU to switch off beamspace compression for selected SRS signals based on control information received from the DU, while continuing to apply quantization to the selected SRS signals.

In Example 10, the subject matter of Examples 1-9 includes, wherein the processor configures the RU to partition the SRS signals into interlaces prior to performing the transform operation, each interlace comprising a subset of resource elements selected with a predefined periodicity.

Example 11 is an apparatus for a distributed unit (DU), the apparatus comprising: a memory configured to store Sounding Reference Signal (SRS) data; and a processor that configures the DU to: receive quantized beamspace coefficients and associated basis information from a radio unit (RU); reconstruct, using the associated basis information, the SRS data in an antenna domain from the quantized beamspace coefficients and associated basis information to form reconstructed SRS data; process the reconstructed SRS data to support at least one wireless communication function; and provide control information to the RU, the control information generated based on at least one of the reconstructed SRS data or results of processing the reconstructed SRS data.

In Example 12, the subject matter of Example 11 includes, wherein the at least one wireless communication function includes at least one selected from channel estimation, beamforming, and resource management based on the reconstructed SRS data.

In Example 13, the subject matter of Examples 11-12 includes, wherein the control information comprising at least one selected from a compression threshold used to determine which coefficients of SRS signals received by the RU are retained during compression of the SRS signals, basis selection to indicate a mathematical basis used to transform the SRS data from the antenna domain to a beam domain, coefficient selection to select a subset of beamspace coefficients from among the coefficients of the SRS signals retained during the compression of the SRS signals, and synchronization parameters that align the RU and DU in time and configuration during compression, transmission, and reconstruction of the SRS data.

In Example 14, the subject matter of Examples 11-13 includes, wherein the associated basis information comprises at least one selected from actual basis vectors, indices identifying selected basis vectors, and oversampling factors.

In Example 15, the subject matter of Examples 11-14 includes, wherein the processor configures the RU to select a frequency resolution for the reconstructed SRS data based on configuration information received from a network controller.

In Example 16, the subject matter of Examples 11-15 includes, wherein the processor configures the RU to update the control information in response to a change in at least one of network conditions or user equipment (UE) requirements.

In Example 17, the subject matter of Examples 11-16 includes, wherein the processor configures the RU to perform channel estimation on the reconstructed SRS data prior to at least one of beamforming or resource management.

In Example 18, the subject matter of Examples 11-17 includes, wherein the processor configures the RU to partition the reconstructed SRS data into interlaces for subsequent processing.

Example 19 is a non-transitory computer-readable storage medium that stores instructions for execution by one or more processors of an apparatus of a radio unit (RU), the instructions, when executed, cause the RU to: receive SRS signals from a plurality of antenna elements; perform a transform operation on the SRS signals to convert the SRS signals from an antenna domain to a beam domain using a selected basis; select, based on a threshold received from a distributed unit (DU), a subset of beamspace coefficients corresponding to high-energy coefficients of the SRS signals in the beam domain; quantize the subset of beamspace coefficients to form quantized beamspace coefficients; associate the quantized beamspace coefficients with basis information; and transmit the quantized beamspace coefficients and associated basis information to the DU for reconstruction of SRS data in an antenna domain.

In Example 20, the subject matter of Example 19 includes, wherein the instructions, when executed, cause the RU to receive control information from the DU, the control information comprising at least one selected from a compression threshold used to determine which coefficients of the SRS signals are retained during compression of the SRS signals, basis selection to indicate a mathematical basis used to transform the SRS signals from the antenna domain to the beam domain, coefficient selection to select the subset of beamspace coefficients from among the coefficients of the SRS signals retained during the compression of the SRS signals, and synchronization parameters that align the RU and DU in time and configuration during compression, transmission, and reconstruction of the SRS signals.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Another example may describe interlace partitioning and compression. This includes the ability to partition SRS signals or channel estimates into interlaces (mutually exclusive subsets of resource elements) independent of the number of multiplexed ports, and to perform compression on a per-interlace basis. This provides the flexibility to dynamically configure the number and periodicity of interlaces based on system requirements or control signaling. In this case, the processor configures the RU to partition SRS signals or channel estimates into a plurality of interlaces, each interlace comprising a subset of resource elements selected with a configurable periodicity, and to perform beamspace compression on each interlace.

Another example may describe composite waveform generation after channel estimation. This involves the process of recombining channel estimates into a composite waveform using defined sequences before interlace-based compression, especially after channel estimation at the RU. In this case, the processor configures the RU to generate a composite waveform by combining channel estimates using predetermined sequences prior to partitioning into interlaces and performing compression.

Another example may describe dynamic and granular control signaling. This involves the DU's ability to provide granular control information to the RU, such as switching off compression for selected SRS signals, restricting the number of compressed coefficients per comb, interlace, or other grouping, and specifying persistence windows for basis application. In this case, the processor configures the RU to receive control information from the DU specifying at least one of: a compression threshold, a restriction on the number of compressed coefficients per grouping, an indication to switch off compression for selected signals, or a persistence window for basis application.

Another example may describe reconstruction of multiple SRS ports and interlaces. This involves ability to reconstruct not only the composite waveform but also the individual SRS transmit ports and interlaces at the DU using the received coefficients and basis information. In this case, the processor configures the DU to reconstruct individual SRS transmit ports and interlace waveforms from the received compressed coefficients and basis information.

Another example may describe persistence and filtering across time/frequency. This involves the use of persistence windows and filtering of SRS vectors across time and frequency for basis construction or channel estimation. In this case, the processor configures the RU to apply persistence and filtering to SRS vectors across time and frequency for basis construction or channel estimation, as specified by control information.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a radio unit (RU), the apparatus comprising:
a memory configured to store Sounding Reference Signal (SRS) signals received from one or more user equipment (UE) ports; and
a processor that configures the RU to:
receive SRS signals from a plurality of antenna elements;
perform a transform operation on the SRS signals to convert the SRS signals from an antenna domain to a beam domain using a selected basis;
select, based on a threshold received from configuration information, a subset of beamspace coefficients corresponding to high-energy coefficients of the SRS signals in the beam domain;
quantize the subset of beamspace coefficients to form quantized beamspace coefficients;
associate the quantized beamspace coefficients with basis information; and
transmit the quantized beamspace coefficients and associated basis information for reconstruction of SRS data.

2. The apparatus of claim 1, wherein the selected basis comprises at least one selected from a discrete Fourier transform (DFT), an oversampled DFT, a singular value decomposition (SVD), and a QR decomposition.

3. The apparatus of claim 1, wherein:
the threshold is received from a distributed unit (DU),
the processor configures the RU to receive control information from the DU,
the control information comprises at least one selected from a compression threshold used to determine which coefficients of the SRS signals are retained during compression of the SRS signals, basis selection to indicate a mathematical basis used to transform the SRS data from the antenna domain to the beam domain, coefficient selection to select the subset of beamspace coefficients from among the coefficients of the SRS signals retained during the compression of the SRS signals, and synchronization parameters that align the RU and DU in time and configuration during compression, transmission, and reconstruction of the SRS data.

4. The apparatus of claim 1, wherein quantization of the subset of beamspace coefficients comprises application of at least one selected from block floating point compression, block scaling compression, and u-law compression to the subset of beamspace coefficients.

5. The apparatus of claim 1, wherein the processor configures the RU to transmit, along with the quantized beamspace coefficients, an indication of a word length of each quantized value.

6. The apparatus of claim 1, wherein the basis information comprises at least one selected from: actual basis vectors, indices identifying selected basis vectors, and oversampling factors.

7. The apparatus of claim 1, wherein:
the threshold is received from a distributed unit (DU), and
the processor configures the RU to receive time offset information from the DU for fast Fourier transform (FFT) window placement.

8. The apparatus of claim 1, wherein the processor configures the RU to apply an identical basis to SRS signals received from an identical comb, SRS symbol, transmit port, section-id, or physical resource block (PRB) set of SRS sounding bandwidth.

9. The apparatus of claim 1, wherein:
the threshold is received from a distributed unit (DU), and
the processor configures the RU to switch off beamspace compression for selected SRS signals based on control information received from the DU, while continuing to apply quantization to the selected SRS signals.

10. The apparatus of claim 1, wherein the processor configures the RU to partition the SRS signals into interlaces prior to performing the transform operation, each interlace comprising a subset of resource elements selected with a predefined periodicity.

11. An apparatus for a distributed unit (DU), the apparatus comprising:
a memory configured to store Sounding Reference Signal (SRS) data; and
a processor that configures the DU to:
receive quantized beamspace coefficients and associated basis information from a radio unit (RU);
reconstruct, using the associated basis information, the SRS data in an antenna domain from the quantized beamspace coefficients and associated basis information to form reconstructed SRS data;
process the reconstructed SRS data to support at least one wireless communication function; and
provide control information to the RU, the control information generated based on at least one of the reconstructed SRS data or results of processing the reconstructed SRS data.

12. The apparatus of claim 11, wherein the at least one wireless communication function includes at least one selected from channel estimation, beamforming, and resource management based on the reconstructed SRS data.

13. The apparatus of claim 11, wherein the control information comprising at least one selected from a compression threshold used to determine which coefficients of SRS signals received by the RU are retained during compression of the SRS signals, basis selection to indicate a mathematical basis used to transform the SRS data from the antenna domain to a beam domain, coefficient selection to select a subset of beamspace coefficients from among the coefficients of the SRS signals retained during the compression of the SRS signals, and synchronization parameters that align the RU and DU in time and configuration during compression, transmission, and reconstruction of the SRS data.

14. The apparatus of claim 11, wherein the associated basis information comprises at least one selected from actual basis vectors, indices identifying selected basis vectors, and oversampling factors.

15. The apparatus of claim 11, wherein the processor configures the RU to select a frequency resolution for the reconstructed SRS data based on configuration information received from a network controller.

16. The apparatus of claim 11, wherein the processor configures the RU to update the control information in response to a change in at least one of network conditions or user equipment (UE) requirements.

17. The apparatus of claim 11, wherein the processor configures the RU to perform channel estimation on the reconstructed SRS data prior to at least one of beamforming or resource management.

18. The apparatus of claim 11, wherein the processor configures the RU to partition the reconstructed SRS data into interlaces for subsequent processing.

19. A non-transitory computer-readable storage medium that stores instructions for execution by one or more processors of an apparatus of a radio unit (RU), the instructions, when executed, cause the RU to:
receive SRS signals from a plurality of antenna elements;
perform a transform operation on the SRS signals to convert the SRS signals from an antenna domain to a beam domain using a selected basis;
select, based on a threshold received from a distributed unit (DU), a subset of beamspace coefficients corresponding to high-energy coefficients of the SRS signals in the beam domain;
quantize the subset of beamspace coefficients to form quantized beamspace coefficients;
associate the quantized beamspace coefficients with basis information; and
transmit the quantized beamspace coefficients and associated basis information to the DU for reconstruction of SRS data in an antenna domain.

20. The non-transitory computer-readable storage medium of claim 19, wherein the instructions, when executed, cause the RU to receive control information from the DU, the control information comprising at least one selected from a compression threshold used to determine which coefficients of the SRS signals are retained during compression of the SRS signals, basis selection to indicate a mathematical basis used to transform the SRS signals from the antenna domain to the beam domain, coefficient selection to select the subset of beamspace coefficients from among the coefficients of the SRS signals retained during the compression of the SRS signals, and synchronization parameters that align the RU and DU in time and configuration during compression, transmission, and reconstruction of the SRS signals.
